(19) United States
(12) Patent Application Publication
(10) Pub. No.: US 2004/0024888 A1
(43) Pub. Date: Feb. 5, 2004

(54) Systems and methods for managing web content and behavior rules engine

(75) Inventors: Craig O. Davis, Meridian, ID (US); Sukh M. Sodhi, Boise, ID (US); Bryce E. Ashey, Boise, ID (US); James C. Coryat, Nampa, ID (US)

Correspondence Address: SNELL & WILMER, ONE ARIZONA CENTER, 400 EAST VAN BUREN, PHOENIX, AZ, 850040001

(73) Assignee: Micron Technology, Inc.

(21) Appl. No.: 10/211,004

(22) Filed: Aug. 1, 2002

(51) Int. Cl. G06F 15/16

(52) U.S. Cl. 709/229; 709/218; 709/203

(57) ABSTRACT

A transaction processing system provides improved flexibility and capability by customizing content provided to the purchaser as the transaction takes place. Content is determined by evaluating one or more rule sets using information previously obtained about the customer and/or the details of the transaction itself. A rules manager module receives a notification from a web server when customer performs a triggering event such as requesting a particular web page from the server. The rules manager provides notification of the event to a rules engine module that suitably retrieves an event tree associated with the event. The event tree contains one or more sets of rules that are evaluated by the rules engine using customer and/or transaction data to produce a catalog of customized actions. The actions are then returned to the rules manager module for creating customized content for the customer.

### FIELD OF INVENTION

The present invention relates generally to computer systems and methods used in electronic commerce.

### BACKGROUND OF THE INVENTION

Electronic commerce has become an increasingly popular medium for business-to-business and business-to-consumer transactions. As more and more individuals and organizations become comfortable using digital networks such as the Internet for purchasing goods and for transacting business online, the digital marketplace becomes increasingly lucrative.

Accordingly, many merchants have established web sites to market products and services directly to consumers around the world. A conventional web site providing retail sale of goods or services typically includes a visual catalog or other description of available products. As consumers select items for purchase, a data entry is made in a virtual “shopping cart” so that the consumer can continue shopping for additional items.

When the consumer is ready to pay for selected items, a “check out” screen is typically provided that allows the user to provide payment and/or shipping information to complete the sale.

A common disadvantage of conventional internet commerce, however, is that most vendor systems are highly impersonal and inflexible. While conventional in-person or “brick and mortar” transactions can be readily customized based upon the circumstances of the transaction, such flexibility is very difficult to build into a computer system. A need therefore exists for a system and technique for managing web content that allows for improved personalization as the transaction is taking place. In particular, there is a need for a system and method to process “customized” electronic transactions that consider the various nuances of the customer and the transaction itself. Such a system should be robust, secure, and highly adaptable to multiple types of customers and transactions.

### SUMMARY OF THE INVENTION

According to various embodiments of the present invention, a transaction processing system overcomes the disadvantages of the prior art by providing customized content to the purchaser as the transaction takes place. Content is determined by evaluating one or more rule sets using information previously obtained about the customer and/or the details of the transaction itself. In an exemplary embodiment, a rules manager module receives a notification from a web server when a customer performs a triggering event such as requesting a particular web page from the server. The rules manager provides notification of the event to a rules engine module that suitably retrieves an event tree associated with the event. The event tree suitably contains one or more sets of rules that are evaluated by the rules engine using customer and/or transaction data to produce a catalog of customized actions. The actions are then provided to the rules manager module to create the customized content. These and other aspects of the invention shall become more apparent when read in conjunction with the accompanying drawing figures and the attached detailed description of exemplary embodiments.

### BRIEF DESCRIPTION OF THE DRAWINGS

The features and advantages of the present invention are hereinafter described in the following detailed description of exemplary embodiments to be read in conjunction with the accompanying drawing figures, wherein like reference numerals are used to identify the same or similar parts in the similar views, and:

FIG. 1 is a block diagram of an exemplary web content system;

FIG. 2A is a sequence diagram of an exemplary process for managing web content;

FIG. 2B is an exemplary XML format suitable for transmitting an event name to a rules engine module;

FIG. 2C is an exemplary XML format suitable for transmitting a rule response collection from a rules engine module to a rules manager module;

FIG. 3 is a flowchart of an exemplary process for navigating an event tree; and

FIGS. 4A-C are hierarchy diagrams of an exemplary event tree as processed in three exemplary transactions.

### DETAILED DESCRIPTION OF EXEMPLARY EMBODIMENTS

According to various embodiments of the invention, the shortcomings of the prior art are overcome by providing a web content management system that includes a rules-based engine for providing customized content “on the fly” as the transaction progresses. A transaction server suitably includes a rules manager module that adjusts content provided from the server to a customer's browser based upon customer data and/or details of the transaction. As the customer proceeds with the transaction, the rules manager identifies certain “events” that trigger a rules engine module. The rules engine module suitably retrieves an appropriate set of rules corresponding to the event in addition to any relevant information about the customer that is maintained by the server. The rules engine module processes the event tree to generate a set of responses that can be translated into “customized” actions to be executed by the rules manager module. Actions taken include providing content or applications to the customer's browser and/or analyzing additional rule sets, as appropriate. After the rules in the event tree are processed, customized content can be identified and readily provided to the user based upon the results of the analysis.

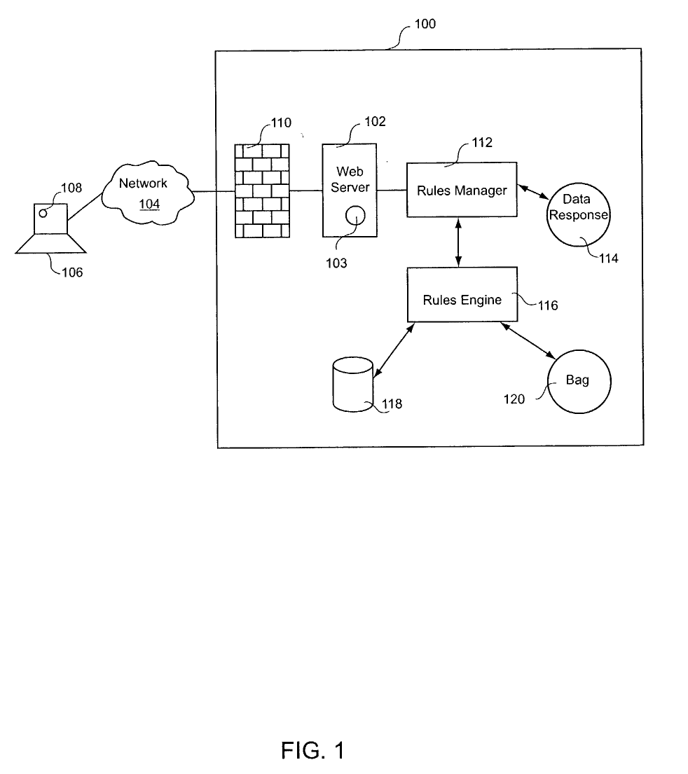

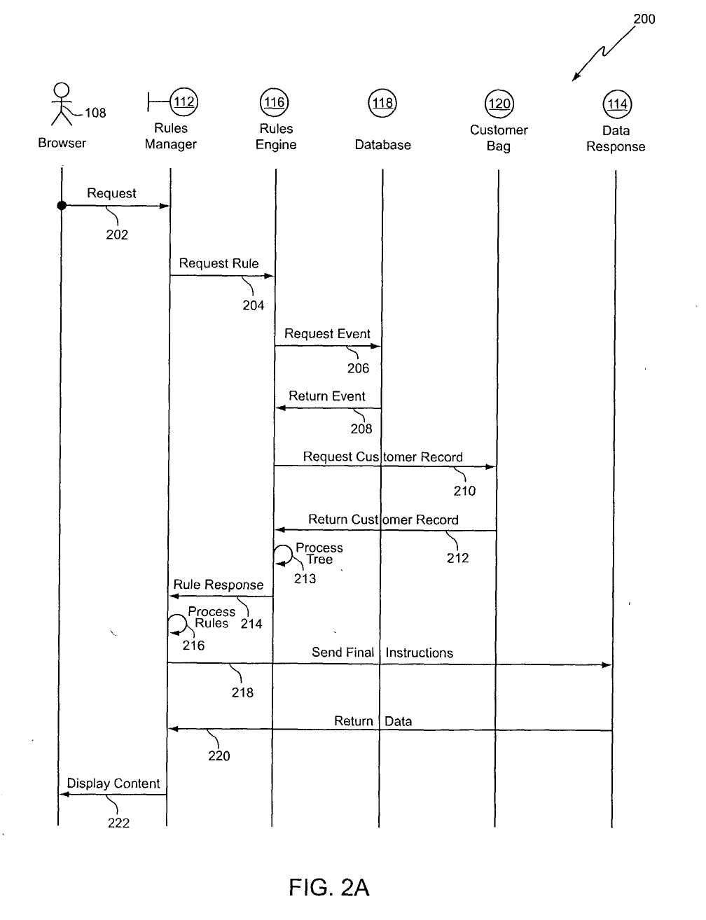

FIG. 1 is a block diagram of an exemplary system for managing web content during an electronic transaction. With reference now to FIG. 1, an exemplary content management system 100 suitably includes a web server 102, a rules manager module 112, a rules engine module 116, a data response module 114, a database 118 and a customer “bag” 120. An optional firewall 110 may also be provided, as described more fully below. Transaction server 100 suitably communicates via a digital network 104 with a customer's computer 106 running a conventional browser application 108.

Network 104 is any digital network capable of transmitting data between server 100 and client computer 106. Although typically referred to herein as the Internet, network 104 may be implemented in alternate embodiments with any public or private network based upon any set of protocols such as TCP/IP, OSI, IP-3, Appletalk, Netware or other protocols. Similarly, customer computer 106 may be any computing device capable of interacting with server 100 via network 104. Accordingly, customer computer 106 may be implemented with any sort of personal computer, workstation, kiosk, personal digital assistant, cellular phone or other device. Examples of conventional browser programs 108 include Microsoft Internet Explorer available from the Microsoft Corporation of Redmond, Wash. or the Netscape Communicator program available from the AOL/Time Warner Corporation of Mountain View, Calif.

Content management system 100 is implemented with one or more computing hosts, which may be personal computers or other workstations executing any version of the WINDOWS, UNIX, LINUX, MacOS or other operating systems. In an exemplary embodiment, server 104 is physically implemented with a cluster of personal computers executing a WINDOWS 2000 or subsequent operating system, along with conventional networking hardware and software interconnecting the various computing hosts. Each of the modules shown in FIG. 1 is intended as a logical component that may be physically executed on any computing platform. Accordingly, some or all of the components and modules shown in FIG. 1 may reside on common computing hosts, and/or may be distributed between hosts or processors as appropriate.

Firewall 110 is any hardware, software and/or data communications barrier that prevents unwanted connections to server 100 from network 104. In an exemplary embodiment, firewall 110 is implemented with router access control lists, software filters, and/or the like. Web server 102 (also referred to herein as “web server interface”) is any application that is capable of interacting with client browser 108 via network 104. Web server 102 may support any appropriate protocols for communication such as the hypertext transport protocol (HTTP) and/or secure HTTP (HTTPS) commonly used on the Internet. In an exemplary embodiment, web server 102 is implemented with the Microsoft Internet Information Server product available from the Microsoft Corporation of Redmond, Wash. Web server 102 further includes a script 103 or other module that initiates contact with the rules tree as described more fully below. Script 103 may be implemented as an active server pages (ASP) script, or with any other appropriate scripting or programming scheme.

Rules manager module 112 (also referred to herein as simply “rules manager”) and rules engine module 116 (also referred to herein as simply “rules engine”) are applications, objects daemons, processes or other software modules configured to implement an event tree to determine content provided or other actions taken by web server 102. In an exemplary embodiment, rules manager module 112 and rules engine module 116 are implemented as dynamically-loaded libraries (DLLs) created using Microsoft Component Object Model (COM) or COM+ technologies. Alternatively, modules 112 and 116 may be implemented with C, C++, C#, Visual Basic, Java, PERL, ActiveX or any other programming or scripting technology.

Rules manager module 112 suitably acts as an interface between web server 102 and rules engine module 116 to manage the content customization process. Rules manager 112 receives an initiating event from server script 103 or another appropriate source and provides information about the event to rules engine 116 for analysis. Rules manager 112 also receives a processed ruleset from rules engine 116 and processes the instructions contained therein as appropriate.

Various embodiments of rules manager 112 include one or more interfaces to external processes operating within server 100. In an exemplary embodiment, rules manager module 112 includes a “GetContent” interface that accepts a name of an initiating event (such as a name of a web page or the like, and as defined more fully below) to begin the rule-evaluating process. The GetContent interface may receive additional parameters such as a template name, template path, template section and/or cache directory to search for pre-built content. If template information is provided, the template may be searched for initiating events specified within the document. The GetClient interface provides an appropriate output that includes content generated from the input values provided. The content may be provided as a string value, as a pointer or other reference to content stored within system 100, or in any other format. Other exemplary interfaces provided by rules manager module 112 may include a DataAccess interface for querying database 118, a LogActivity interface for logging internal method calls for debugging and profiling purposes, and/or a Ping interface to respond to external queries if module 112 is in a healthy and responsive state. Other embodiments of rules manager module 112 may include additional and/or different interfaces, methods or objects as may be appropriate.

Rules engine module 116 suitably receives an event indicator from rules manager module 112, processes the appropriate rule tree associated with the event, and retunis a rule response collection or other appropriate response to rules manager 112. Rules engine module 116 includes one or more interfaces to other programs or modules within system 100. In an exemplary embodiment, rules engine module 116 includes an EvaluateRequest interface that suitably receives a request supplying events to be processed and that returns results of evaluations performed. Both the request and the response processed by the EvaluateRequest interface may be in extensible markup language (XML) format, or in any other format as described more fully below. Rules engine module 116 may also include a DataAccess interface to database 118, a Ping interface, and/or any other appropriate modules or interfaces.

Database 118 is any database system capable of storing event trees, rule sets and other data for use within system 100. Database 118 may be any relational, object-oriented or other database configured to store the various event trees associated with the various initiating events identified by rules manager 112. In an exemplary embodiment, database 118 is implemented with database management software available from the Oracle Corporation of San Jose, Calif. Other appropriate database management programs include Microsoft SQL Server, IBM's DB/2, MySQL, or any other database management program. Event trees are stored in any format within the database management program.

Each event tree stored in database 118 suitably points to one or more appropriate rule sets. An event tree is a grouping of rule sets that are evaluated to determine a logical outcome based upon customer attributes and the like. Rule sets are groups of rules that make up each node of the event tree. A rule is conventionally defined as having an expression that can be resolved to a “true” or “false” result. Rules typically also specify one or more actions to take if the result is “true”. Typically, the expression portion of the rule includes a “left hand side” (LHS) and a “right hand side” (RHS) separated by an operator such as an equal sign (“=”), not-equal sign (“!=”), greater-than or less-than sign (“>” or “<”) or some combination thereof (e.g. “>=”, “=<”) or the like. An exemplary expression “Cart_Value>100”, for example, might evaluate a variable (“Cart_Value”) that is associated with the customer. In this example, the LHS is the variable “Cart_Value”, the RHS is the threshold value 100 and the operator is the greater-than sign “>”. To continue with this exemplary expression, the rule might return a “true” result if the value of the customer's shopping cart exceeds $100, indicating that an action associated with the rule should be taken. Otherwise, the expression will evaluate to “false”, typically indicating that no action should be taken in response to this rule. Either or both of the LHS and RHS may contain sub-expressions, references to customer information, data values and/or the like.

Each rule in a rule set is typically associated with a particular expression, and includes a default value if no rule in the set is evaluated to “true”. That is, typically only one rule in a particular ruleset will evaluate to “true” for any particular set of input values. Various types of actions can be associated with each rule, including navigational actions (i.e. evaluating additional rulesets) or final actions (i.e. generating a content element such as a data value, HTML content, a web component, or the like). The actions associated with rules in the ruleset evaluating to “true” are typically collected in a rule response collection for subsequent processing. In addition to the navigational or final action associated with each rule, each rule may be associated with an additional optional action that is performed if the rule evaluates to “true”, as described more fully below. The various rules and actions taken in response to rule evaluations are described in additional detail below.

Customer bag 120 is any data structure or other module capable of storing information about the customer. In an exemplary embodiment, customer bag 120 is stored within database 118; alternatively, customer bag 120 may reside within a separate database or within any of the other modules of server system 100. For the discussion herein, database 118 is defined to logically include customer bag 120 even if customer bag data is stored in a separate physical location from the event tree data. Information maintained within bag 120 varies widely from embodiment to embodiment, but may include demographic information, information about previous purchases (e.g. value of prior purchases, number of items purchased, brand of items purchased, etc.), information from the customer's shopping cart (i.e. the items selected for purchase) or any other information associated with the customer. In an exemplary embodiment, customer bag 120 is maintained as an unordered collection of named attribute values specific to each single customer. For a merchant site concerned with retail sale of computer components, for example, customer bag 120 may maintain such information as the purchaser's mailing address, payment information, computer brand and model, components previously purchased, frequency of previous visits or purchases from the site, number of items and dollar value of the current shopping cart, the purchaser's organizational status (individual, corporate, government, education, etc.) and/or the like. Any or all of these data items may be processed within rules engine 116 to determine customized content for the customer.

Data response module 114 is an optional content formatting program that creates customized content to implement the rules analyzed by rules engine 116. Data response module 114 is any program, routine, object or the like that is capable of building user interface content. Although shown as a separate module in FIG. 1, alternate embodiments may incorporate the functionality of data response module 114 into rules manager 112 or web server 102. An example of a data response module is described in U.S. patent application Ser. No. 09/876,825 filed on Jun. 6, 2001, which is incorporated herein by reference.

In operation, then, content management system 100 is operable to identify an event initiated by a user's browser 108, to request and process an event tree associated with the event, and to generate custom content back to the user based upon the event and data maintained about the customer in an event bag 120.

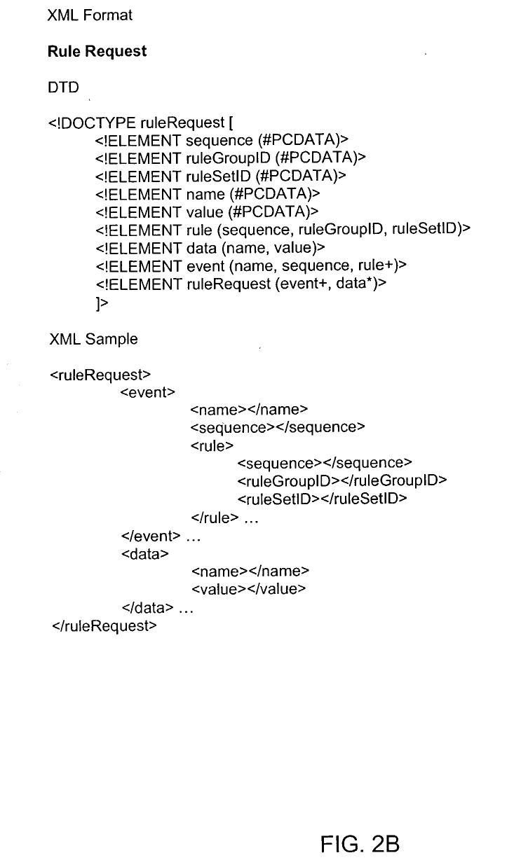

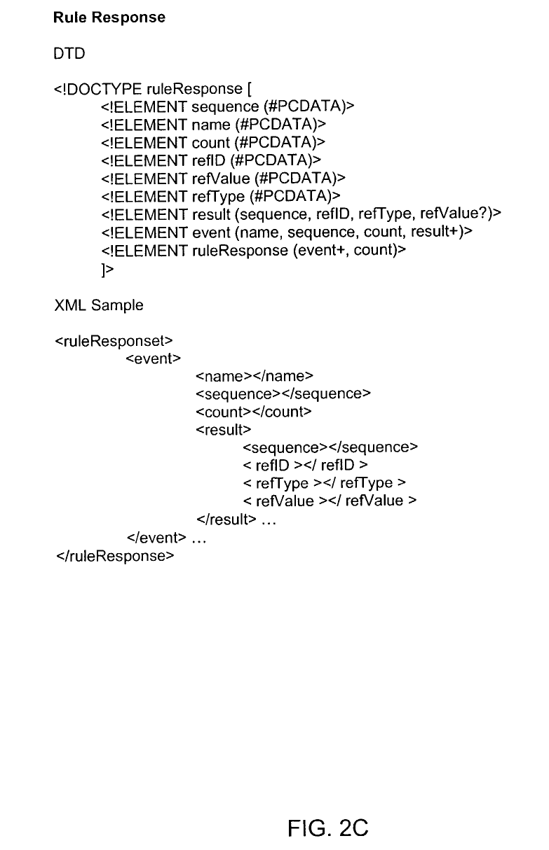

FIG. 2 is a sequence diagram of an exemplary process for managing web content. With reference now to FIG. 2, an exemplary process 200 suitably begins with a user browsing through a web site. As the user manipulates a browser program 108 to navigate through a vendor web site hosted by a server 103, browser 108 requests documents (in hypertext markup language or another appropriate format) that are displayed for the user. The user may then select hyperlinks or other navigational tools to continue browsing the site.

When server 103 receives a request for a page associated with a particular event, an ASP script 103 suitably passes the name of the event (or another appropriate event identifier) 202 to rules manager 112 to initiate the event tree process. If browser 108 requests a page “index.asp” from server 102, for example, script 103 may identify this request as an event and call the GetContent interface associated with rules manager 112, passing the “index” name as a parameter. Information about the user (i.e. requesting URL, cookie data, identity data or the like) may also be provided in various embodiments. In a further exemplary embodiment, rules manager 112 is responsive to multiple events that may be triggered simultaneously by the user. Requesting a particular page, for example, may initiate multiple events associated with that page. Accordingly, rules manager 112 may receive multiple page names or other events for simultaneous processing. In such cases, each call from script 103 to the GetContent interface suitably generates a separate routine executing within rules manager 112 for simultaneous processing.

When rules manager 112 receives message 202 indicating that an event has occurred, rules manager 112 suitably passes the event identifier to the EventRequest interface of rules engine 116 (step 204) to request a set of rules to process. Request 204 may be in XML format (as shown the exemplary request shown in FIG. 2B) or in any other suitable format. The rules engine receives message 204 and requests the appropriate event tree associated with the event from database 118. Database 118 accordingly receives a request or query 206 for the event tree, processes the request to identify the event tree in database 118, and returns the tree to rules engine as event tree response 208. In an exemplary embodiment, query 206 and/or response 208 are provided in structured query language (SQL) format, although other formats such as XML or the like could also be used. Rules engine also requests and receives customer data from customer bag 120 (steps 210 and 212, respectively). Customer data suitably includes demographic information, purchase history, information about the customer's shopping cart (e.g. number of items, total value, etc.), information from the customer's URL or cookie, or any other appropriate information. Rules engine 116 may retrieve all relevant data in customer bag 120 with one request 210, or may place multiple requests 210 to obtain particular data from customer bag 120 as needed. In an exemplary embodiment, customer bag data is retrieved using SQL queries to database 118, although other query formats or storage locations for customer bag 120 could also be used.

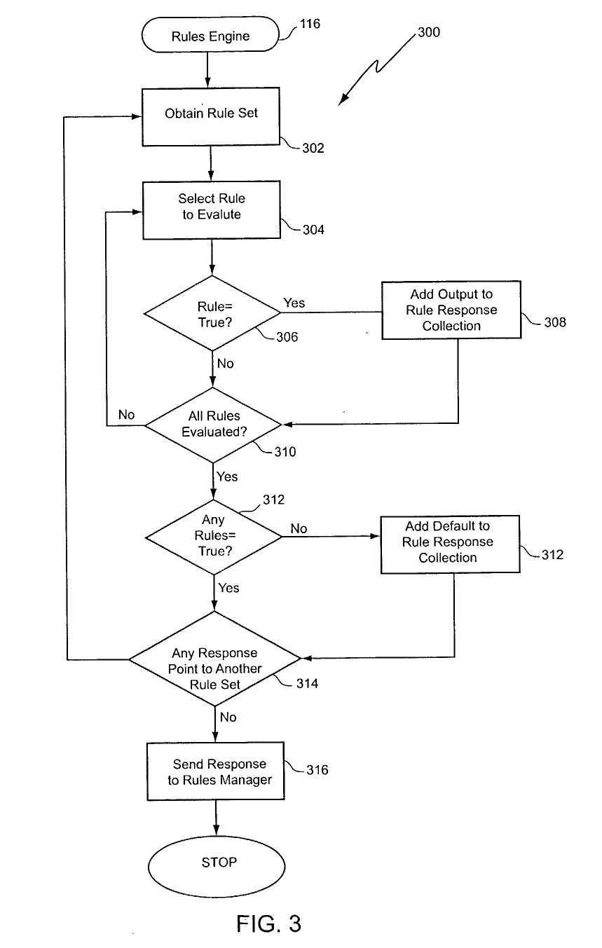

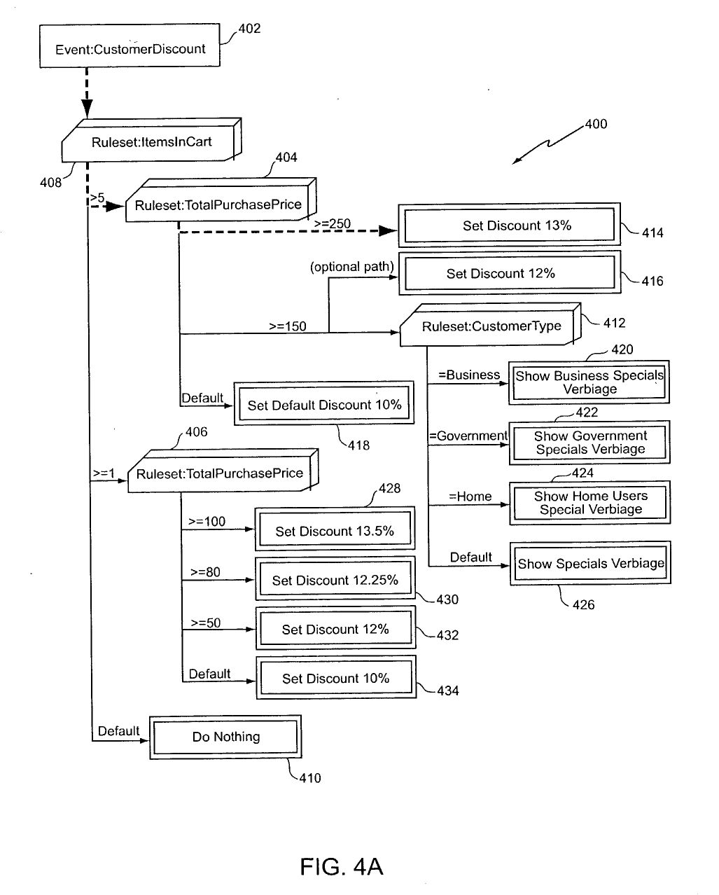

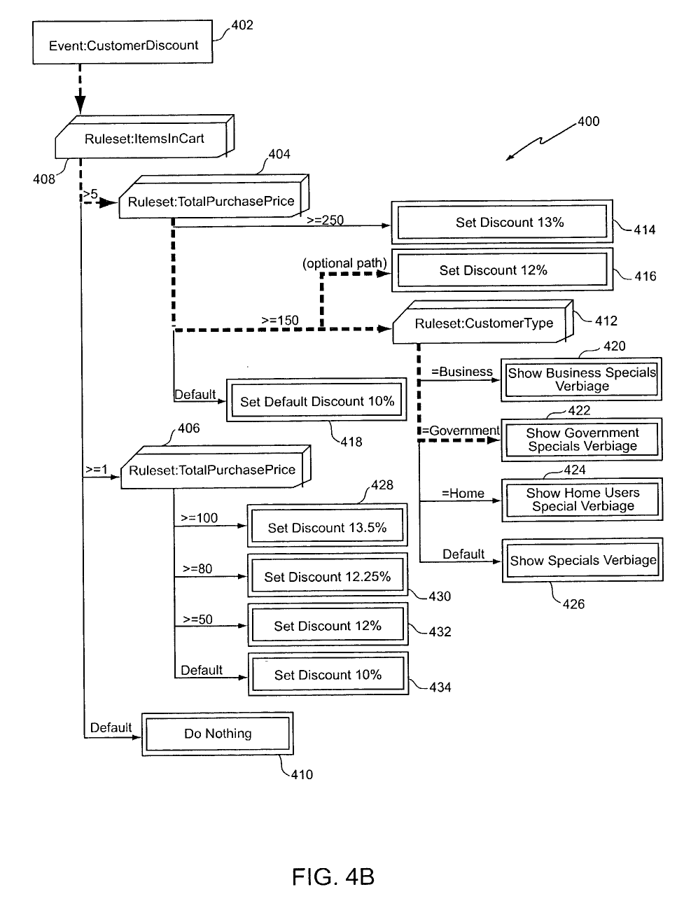

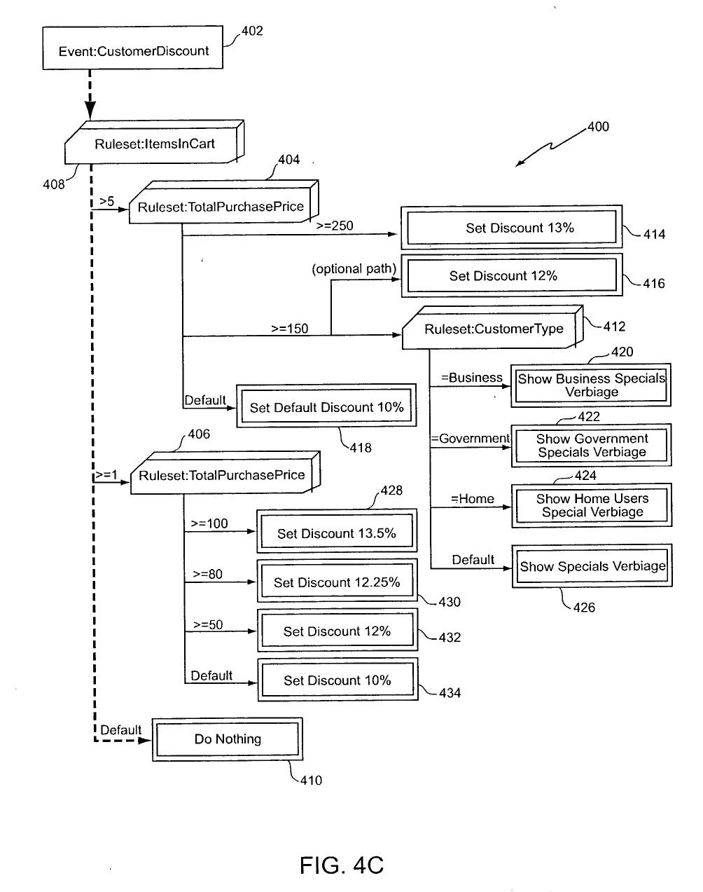

After the rules engine receives the relevant event tree and customer bag information from database 118, the event tree is processed or otherwise analyzed as appropriate (step 213). An exemplary event tree is shown in FIGS. 4A-C and an exemplary process for traversing the event tree is described below in conjunction with FIG. 3. When the event tree is processed, the actions associated with rules that evaluated to “true” produce a rule response collection that can be provided to rules manager 112 (step 214). The rule response collection may be provided in an XML or other format such that the relevant actions can be readily extracted and processed by rules manager 112 (step 216). An exemplary XML format suitable for rule response collection 214 is shown in FIG. 2C.

Rules manager 112 then processes rule response collection 214 as appropriate. Exemplary rule responses include providing HTML or executable content to the user, processing a subsequent event tree, or the like. In an exemplary embodiment, final instructions 218 for generating content are sent to data response module 114, which generates HTML or other code in response to the instructions and/or parameters provided by rules manager 112. The completed code 220 is returned to rules manager 112, which appropriately relays the content to user's browser 108 (step 222) via web server 102 (FIG. 1). In an alternate embodiment, code generated by data response module 114 may be provided directly to web server 102 or to browser 108.

FIG. 3 is a flowchart of an exemplary process 300 for analyzing an event tree at rules engine 116. With reference now to FIG. 3, an exemplary process 300 suitably begins with rules engine 116 obtaining the relevant event tree from database 118 as described above. When the event tree is received, processing begins by analyzing the rule set associated with the first node on the tree. Accordingly, rules engine 116 appropriately obtains the relevant rule set (step 302) and selects the first rule to evaluate (step 304). The rules engine evaluates each rule to determine if the rule evaluates to “true” or “false” (step 306). Evaluating the rule may be as simple as comparing an element of data from the customer bag with a threshold value, for example, or may be as complicated as evaluating a regular expression with data retrieved from database 118, customer bag 120 or the like. If the rule evaluates to “true”, then the action associated with the rule is appropriately added to the rule response collection 214 (step 308), and processing moves on to the next rule (step 310). Alternatively, processing of the rule set may terminate immediately upon identification of a rule that evaluates to “true” if the rulesets are created such that only one rule in each set can logically be true for any set of data.

If all of the rules in the set are evaluated, rules engine 116 suitably determines whether any rules in the set have evaluated to “true” (step 312). If not, a default action is appropriately added to rule response collection 214 (step 312). If any of the actions identified in the ruleset contain a reference to another ruleset (step 314), then that ruleset is retrieved (step 302) and the process begins anew. If all of the rules have been evaluated and no further rulesets are referenced, then the rule response collection is provided to rules manager 112 (step 316) and the process is complete.

FIGS. 4A-C are hierarchy diagrams of an exemplary event tree. With reference to FIGS. 4A-C, an exemplary event tree 400 associated with a “CustomerDiscount” event 402 suitably includes rulesets to process transaction data based upon the number of items in the customer's shopping cart, the total purchase price of the transaction, and/or the type of customer. CustomerDiscount event 402 may be triggered by, for example, a user requesting a “CustomerDiscount” page from web server 102 (FIG. 1), by requesting an “OrderCheckout” page (which may have multiple associated events), or by any other action by the customer. As shown in FIGS. 4A-C, event tree 400 is evaluated at rules engine 116 to determine an optional discount that may be applied to the customer's purchase.

The first ruleset 408 in event tree 400 suitably corresponds to the number of items in the customer's cart. If the customer has multiple items in the cart, separate rulesets 404 and 406 allow evaluation of the total purchase price for the items in the cart to further evaluate a discount. If the customer has more than one item but less than five items in the shopping cart, for example, a second ruleset 406 is evaluated to assign a cost discount from 10 to 13.5% based upon the TotalPurchasePrice of the items (rules 428, 430, 432 and 434). If a rule evaluates to true in the ruleset, a corresponding action is processed. As described above, actions may be “final” or “transactional” in nature. A transactional action typically involves retrieving and analyzing a subsequent ruleset. A final action involves providing web content or web objects, or adjusting a data value in response to data from customer bag 120. Optional final rules may also be included with any rule that evaluates to true.

With reference to FIG. 4A, the case is illustrated whereby a customer has five items in the shopping cart with a total purchase price in excess of $250. As shown in the Figure, the expression for the topmost rule in ruleset 408 (“ItemsInCart>5”) evaluates to true. The action associated with this rule is navigational in that it specifies another ruleset 404 to evaluate, so rules engine 116 obtains ruleset 404 to evaluate the TotalPurchasePrice of the items in the cart. In the case shown in FIG. 4A, the total purchase price is in excess of $250. Accordingly, the LHS of the first rule in ruleset 404 (“TotalPurchasePrice>=250”) evaluates to true, and the action of setting the discount amount equal to 13% is suitably added to rule response collection 214 (FIG. 2). After tree 402 is analyzed, rules engine 116 suitably provides the rule response collection to rules manager 112 for processing of the actions in the collection.

With reference now to FIG. 4B, the case is illustrated whereby a government customer has more than five items in the shopping cart and a total purchase price between $150 and $250. Like the case shown in FIG. 4A, the first rule in ruleset 408 evaluates to “true” to shift analysis to TotalPurchasePrice ruleset 404. In this case, however, the first expression (“TotalPurchasePrice>=250”) is false. The second expression (“TotalPurchasePrice>=150”) is therefore considered, which in this case evaluates to “true”. The actions associated with this rule include an optional action 416 to set a discount equal to 12%. The rule also has an associated navigational action 412 to analyze an additional ruleset 412 relating to the CustomerType. Actions in ruleset 412 provide customized content verbiage for business customers 420, government customers 422, or home users 424. Users that do not fall into any of these categories suitably receive a default message 426. The verbiage or other content provided by the rule may include, for example, special sales or promotions oriented toward a particular class of users. In the present case, the second rule 422 evaluates to “true” for a government user, so the “final” action of presenting government-oriented verbiage is appropriately stored in the rule response collection along with the 12% discount action indicated by rule 416. In an exemplary embodiment, a pointer or identifier to the relevant content is stored in rule response collection 214 such that rules manager 112 or data response module 114 can retrieve the appropriate content from database 118 or another appropriate location. Content that may be referenced or modified by final rule actions includes HTML text and/or web components (e.g. JAVA applets, ActiveX controls, etc.). Final rule actions may also modify data values such as the “discount” value described in FIGS. 4A-C.

FIG. 4C shows the case where CustomerDiscount event 402 is processed when no items are in the shopping cart. Rules engine 116 appropriately processes the expressions for the first and second rules, neither of which evaluates to “true”. Accordingly, the default action 410 of “Do Nothing” is placed in the rule response collection, indicating that no discount is appropriate when no items have been purchased.

A system for customizing web content based upon customer/user attributes is therefore includes a rules manager module in communication with a rules engine. When a user triggers an initiating event, the event is passed from the rules manager to a rules engine, which retrieves an event tree with one or more rulesets based upon the event. The rules engine evaluates the rulesets using customer information to prepare a collection of actions that can be executed to prepare customized content for the user. Accordingly, systems, methods and devices for processing web content in conjunction with a behavior rules engine are appropriately provided. The subject matter described herein is particularly suited for use in connection with electronic commerce. As a result, the several exemplary embodiments are primarily described herein in that context. It should be recognized, however, that such description is not intended as a limitation on the use or applicability of the present invention, but is instead provided merely to enable a full and complete description of an exemplary embodiment. In practice, however, the systems, methods and devices disclosed herein could be used to manage or distribute any type of electronic content in any context, including publishing, entertainment and the like.

The particular implementations shown and described herein are examples of the invention and are not intended to otherwise limit the scope of the invention in any way. The connecting lines shown in the various figures contained herein are intended to represent exemplary functional relationships and/or physical couplings between the various elements. It should be noted that many alternative or additional functional relationships, physical connections or logical connections may be present in a practical content management system. Further, the various software components described herein could be stored on any digital, optical, wireless or magnetic storage medium such as a compact disk, floppy disk, digital memory, optical disk or the like.

The corresponding structures, materials, acts and equivalents of all elements in the following claims are intended to include any structures, materials or acts for performing the functions in combination with other claimed elements as specifically claimed. The scope of the invention should be determined by the appended claims and their legal equivalents, rather than by the examples given above. No item or component is essential to the practice of the invention unless the element is specifically described herein as “critical”, “essential” or “required”.

What is claimed is:

1. A method of processing a transaction across a digital network, the method comprising the steps of:
receiving a request from a purchaser via a digital network;
passing an event name associated with the request to a database to retrieve a rule set associated with the event name;
evaluating the rule set using data associated with the purchaser to determine a responsive action; and
executing the responsive action to provide a response to the purchaser via the digital network.

2. The method of claim 1 wherein the step of evaluating the rule set comprises the step of retrieving at least a portion of the data associated with the purchaser from the database.

3. The method of claim 2 wherein data associated with the purchaser comprises identity information about the purchaser.

4. The method of claim 2 wherein the data associated with the purchaser comprises uniform resource locator (URL) information associated with the request.

5. The method of claim 2 wherein the data associated with the purchaser comprises information from an active server page (ASP) script.

6. The method of claim 1 wherein the responsive action comprises a navigational action.

7. The method of claim 6 wherein the navigational action comprises processing a second rule set.

8. The method of claim 7 wherein the responsive action further comprises providing a hypertext markup language (HTML) file to the purchaser

9. The method of claim 1 wherein the responsive action comprises a final action.

10. The method of claim 9 wherein the final action comprises providing a hypertext markup language (HTML) file to the purchaser.

11. The method of claim 9 wherein the final action comprises a data value.

12. The method of claim 9 wherein the final action comprises providing a web component to the purchaser.

13. The method of claim 1 wherein the rule set comprises a plurality of rules, each of the rules comprising an expression and an action.

14. The method of claim 13 wherein the step of applying the rule set comprises, for each of the plurality of rules, evaluating the expression to determine a true or false result.

15. The method of claim 13 wherein the responsive action comprises an action from each of the plurality of rules for which the result is true.

16. A method of processing a transaction via a digital network, the method comprising the steps of:
receiving a request from a purchaser at a rules manager via the digital network;
passing an event name associated with the request to a rules engine to retrieve a rule set associated with the event name from a database;
evaluating the rule set at the rules engine to determine a responsive action; and
executing the responsive action at the rules manager to respond to the request via the digital network.

17. The method of claim 16 wherein the request comprises a request for an HTML document.

18. The method of claim 16 wherein the evaluating step comprises obtaining information about the customer from the database.

19. The method of claim 16 wherein the responsive action comprises a navigational action referencing a second event name.

20. The method of claim 16 wherein the responsive action comprises a final action referencing data to be provided to the customer.

21. A data processing system comprising:
a server interface to a digital network;
a database configured to store customer information and rules in formation;
a rules manager module configured to receive a request from a customer via the server interface; and
a rules engine module configured to receive an event name from the rules manager module in response to the request, to query the database with the event name to obtain rules information as a function of the event name and to obtain customer information about the customer, to process the rule information using the customer information, and to provide a result to the rules manager module.

22. The data processing system of claim 21 wherein the rules manager module is further configured to receive the result from the rules engine and to execute the result to respond to the request from the customer.

23. The data processing system of claim 21 wherein the interface comprises an active server pages (ASP) script.

24. The data processing system of claim 21 wherein the result comprises an HTML document.

25. A method of providing customized content to a purchaser, the method comprising the steps of:
receiving a notification of an event triggered by the customer;
providing the event to a rules engine to initiate a rules-based analysis of the event using data about the customer;
obtaining a catalog of actions from the rules engine; and
executing the actions in the catalog to create the customized content for the purchaser.

26. The method of claim 25 wherein the executing step comprises providing at least one of the actions to a data response module to prepare at least a portion of the customized content.

27. The method of claim 25 wherein the event comprises a request for a web page.

28. A method of processing customized content for a customer, the method comprising the steps of:
receiving a notification of a triggering event executed by the customer;
retrieving an event tree associated with the event from a database, wherein the event tree comprises at least one set of rules, each rule having an expression and an action;
analyzing the event tree using information about the customer to create a collection of actions associated with the event; and
providing the collection of actions to create the customized content for the customer.

29. The method of claim 28 wherein the analyzing step comprises evaluating each of the expressions using customer data.

30. The method of claim 29 wherein the customer data comprises information obtained from an electronic shopping cart associated with the customer.

31. The method of claim 29 wherein each of the expressions evaluate to a “true” or “false” state.

32. The method of claim 31 wherein the evaluating step comprises storing the action associated with a rule in the collection of actions if the expression associated with the rule evaluates to the “true” state.

33. A method of providing customized content to a customer, the method comprising the steps of:
receiving a name of an event triggered by the customer from a web server at a rules manager;
providing the name of the event from the rules manager to a rules engine;
retrieving an event tree associated with the event from a database;
analyzing the event tree at the rules manager using information about the customer to create a collection of actions;
providing the collection of actions to the rules manager; and
executing the collection of actions at the rules manager to produce the customized content for the customer.

34. A system for processing a transaction across a digital network, the system comprising:
means for receiving a request from a purchaser via a digital network;
means for passing an event name associated with the request to a database to retrieve a rule set associated with the event name;
means for applying the rule set using data associated with the purchaser to determine a responsive action; and
means for executing the responsive action to provide a response to the purchaser via the digital network.

35. A system for providing customized content to a customer, the system comprising:
means for receiving a notification of a triggering event executed by the customer;
means for retrieving an event tree associated with the event from a database, wherein the event tree comprises at least one set of rules, each rule having an expression and an action;
means for analyzing the event tree using information about the customer to create a collection of actions associated with the event; and
means for providing the collection of actions to create the customized content for the customer.

36. A system for providing customized content to a customer, the system comprising:
a web server configured to provide a notification of a triggering event executed by the customer;
a rules engine configured to retrieve an event tree associated with the event from a database, and to processing the event tree using customer information to create a collection of actions; and
a rules manager module configured to receive the notification from the web server, to notify the rules engine of the event, to process the collection of actions to thereby create the customized content, and to provide the customized content to the customer via the web server.

37. A digital storage medium having computer-executable instructions stored thereon, wherein the instructions are configured to implement a method comprising the steps of:
receiving a notification of an event triggered by the customer;
providing the event to a rules engine to initiate a rules-based analysis of the event using data about the customer;
obtaining a catalog of actions from the rules engine; and
executing the actions in the catalog to create the customized content for the purchaser.

38. A digital storage medium having computer-executable instructions stored thereon, wherein the instructions are configured to implement a method of processing customized content for a customer, the method comprising the steps of:
receiving a notification of a triggering event executed by the customer;
retrieving an event tree associated with the event from a database, wherein the event tree comprises at least one set of rules, each rule having an expression and an action;
analyzing the event tree using information about the customer to create a collection of actions associated with the event; and
providing the collection of actions to create the customized content for the customer.
